(19) United States
(12) Patent Application Publication
(10) Pub. No.: US 2020/0226376 A1
(43) Pub. Date: Jul. 16, 2020

(54) IDENTIFICATION AND ACCESS CONTROL USING WEARABLE TOKENS

(71) Applicant: ROK Mobile International Ltd., Culver City, CA (US)

(72) Inventor: Jonathan Kendrick, Culver City, CA (US)

(21) Appl. No.: 16/249,680

(22) Filed: Jan. 16, 2019

(51) Int. Cl. G06K 9/00; G06N 20/00; G07C 9/00

(52) U.S. Cl. CPC G06K 9/00664; G07C 9/00111; G06N 20/00; G06K 9/00208

(57) ABSTRACT

Identification and access control using a wearable token are provided. In some embodiments, a mobile device can initiate execution of an application that presents an instruction to acquire an image of a wearable token. As part of execution of the application, the mobile device can acquire the image of the wearable token via a camera module included in the mobile device. In some instances, the mobile device can detect defined markings on the image of the wearable token. A first marking of the defined markings can have specific semantics and a second marking of the defined markings can encode an identity linked to the wearable token. In response to at least the first marking, the mobile device can direct an access control apparatus to perform a defined operation. In response to the second marking the mobile device can direct the display device to present the identity.

### BACKGROUND

Providing identification generally entails presenting some form of dedicated card. Similarly, access to restricted areas generally can be accomplished by using a dedicated physical key or portable keycard. In some instances, custom expensive equipment can be utilized to allow a mobile device to be relied upon for access to a restricted area. Not only are the foregoing instruments of identification and access impractical to carry in certain restricted spaces (swimming pools, soccer fields, etc.) but it can be expensive and time consuming to replace them should they be damaged or lost. Further, even when access to a restricted area may be accomplished with more practical instruments, the potential for forging can drastically compromise the reliability of identification and/or access control based on such instruments. These and other shortcomings are addressed herein.

### SUMMARY

It is to be understood that both the following general description and the following detailed description are exemplary and explanatory only and are not restrictive. The present disclosure recognizes and addresses, in at least some embodiments, the issue of monitoring identification and controlling access to a location. Embodiments of the disclosed technologies provide, individually or in combination, identification and access control using wearable tokens. Wearable tokens of various morphologies can be utilized. For example, a wearable token can be embodied in or can include an essentially planar object. As another example, a wearable token can be embodied in or can include a three-dimensional object. The wearable tokens can be customized for a particular live event or a specific bearer of a wearable token. Live events can include, for example, sports event, concerts, weddings, family reunions, cultural events, conferences and trade shows, and the like. Accordingly, in some embodiments, a wearable token can include markings (e.g., arrangements of marks or visual elements) where at least one of the marking can have respective specific semantics.

Regardless the morphology of a wearable token, in some embodiments, a mobile device can initiate execution of an application that presents an instruction to acquire an image of the wearable token. The application can reside in the mobile device and can be installed as either hardware or software. In hardware, as an example, the application can be embodied in or can constitute a dedicated integrated circuit, such as an application specific integrated circuit (ASIC) or a field-programmable gate array (FPGA).

Such an instruction can be presented in a display device included in the mobile device. As part of execution of the application, the mobile device can acquire the image of the wearable token via a camera module included in the mobile device.

The mobile device can analyze the acquired image to determine if defined markings are present on the image of the wearable token. Thus, in some instances, the mobile device can detect multiple defined markings on the image, where a first marking of the group of defined markings has specific semantics. The first marking can convey, in one example, a name of a live event or a type of the live event. In another example, the first marking can convey a role (such as bouncer, security guard, janitor, on-site contractor, musician, attendee, etc.) linked to the wearable token. A second marking of the group of defined markings detected by the mobile device can convey a unique element that encodes an identity linked to wearable token, such as the identity of a bearer of the wearable token.

In response to at least the first marking, the mobile device can direct an apparatus to perform a defined operation. The apparatus can be remotely located relative to the mobile device and can be untethered to the mobile device. Performance of the defined operation can permit or otherwise facilitate, for example, controlling access to a particular space or navigating within the particular space. In addition, or as an alternative, the mobile device can direct the display device to present the identity linked to the wearable token in response to at least the second marking.

Additional features or advantages of the disclosure will be set forth in part in the description which follows, and in part will be apparent from the description, or may be learned by practice of this disclosure. The advantages of the disclosure can be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 illustrates an example of an operational environment for access control and identification monitoring, in accordance with one or more embodiments of the disclosure.

FIG. 2A illustrates an example of an application module for access control and identification monitoring, in accordance with one or more embodiments of the disclosure.

FIG. 2B illustrates an example of a mobile device for access control and identification monitoring, in accordance with one or more embodiments of the disclosure.

FIG. 3 illustrates another example of an operational environment for access control and identification monitoring, in accordance with one or more embodiments of the disclosure.

FIGS. 4-6 illustrate respective examples of a method for providing identification and controlling access using a wearable token, in accordance with one or more embodiments of this disclosure.

FIG. 7 illustrates an example of a computing environment in accordance with one or more embodiments of the disclosure.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The methods and systems disclosed herein may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As is described in greater detail below, embodiments of the present disclosure include devices, techniques, and computer program products that, individually or in combination, permit using wearable tokens for identification and access control. In some embodiments, a mobile device can initiate execution of an application that presents an instruction to acquire an image of a wearable token. The mobile device can be embodied in, for example, a laptop computer, a smartphone, a portable videogame terminal, or any other type of mobile user device. As part of execution of the application, the mobile device can acquire the image of the wearable token by means of a camera module included in the mobile device. In some instances, the mobile device can detect a group of defined markings on the image of the wearable token, where a first marking of the group of defined markings has specific semantics. A second marking of the group of defined markings detected by the mobile device can convey a unique element that encodes an identity linked to wearable token, such as the identity of a bearer of the wearable token.

In response to at least the first marking, the mobile device can direct an apparatus to perform a defined operation. Performing the defined operation can permit or otherwise facilitate, for example, controlling access to a particular space or navigating within the particular space. In addition, or as an alternative, the mobile device can direct the display device to present the identity linked to the wearable token in response to at least the second marking.

Although some embodiments of the disclosure are illustrated herein with reference to wearable token that includes a removable tattoo, the disclosure is not limited in that respect. Indeed, the principles and practical elements of the disclosure can be implemented for other types of wearable tokens, such as a patch, a t-shirt, a sports event bib, a badge, an ornament, and the like.

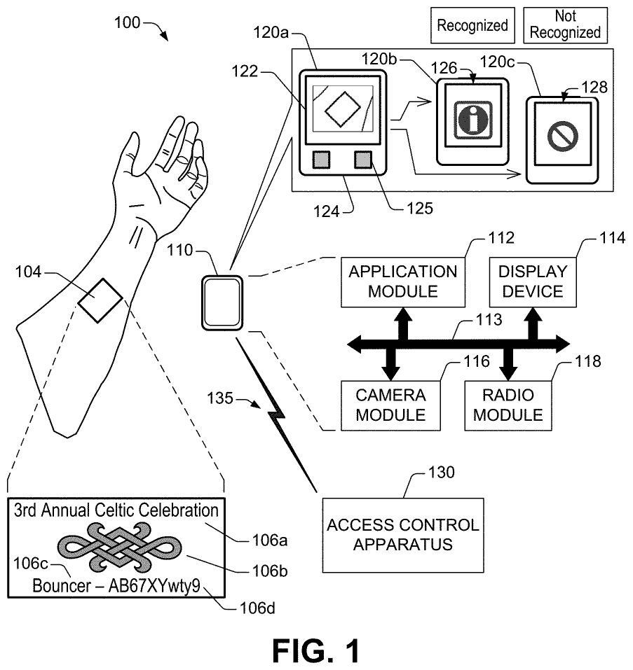

With reference to the drawings, FIG. 1 illustrates an example of an operational environment 100 for access control and/or identification monitoring using a wearable token, in accordance with one or more embodiments of the disclosure. The operational environment 100 includes a mobile device 110 that can acquire an image of a removable tattoo 104 (or, in some embodiments, another type of wearable token). Based at least on the image, the mobile device 110 can control access and/or monitor identification of a bearer of the removable tattoo 104. While the mobile device 110 is generically depicted as a tablet computer, the disclosure is not limited to such a type of device. Elements of the functionality of the operational environment 100 and other environments can be implemented in other types of user devices, such as a laptop computer, a smartphone, a portable videogame terminal, and other types of mobile user devices.

More concretely, the mobile device 110 can initiate execution of an application resident in the mobile device 110. The application can be embodied in or can constitute, for example, an application module 112. The application can be installed in the mobile device 110 as hardware, software, or a combination of both. The execution of the application can cause a display device 114 integrated into the mobile device 110 to display an instruction to acquire an image of a wearable token, such as the removable tattoo 104. For example, as is illustrated in FIG. 1, the display device 114 can present a user interface (UI) 120a that includes a first visual element 124 that embodies or otherwise conveys such an instruction. The UI 120a also includes a second visual element 122 that serves as a viewport to acquire the image. The UI 120a further includes a third visual element 125 that permits or otherwise facilitates confirming the acquisition of the image.

In some embodiments, the first visual element 124 can be selectable. Selection of the first visual element 124 can cause a camera module 116 integrated into the mobile device 110 to acquire a picture of the removable tattoo 104 (or, in some embodiments, another wearable token). The camera module 116 can acquire images within a portion of the electromagnetic radiation spectrum that is visible to the human eye. The camera module 116 also can acquire images outside such a portion of the electromagnetic radiation spectrum, including infrared and/or ultraviolet portions. The camera module 116 can include lenses, filters, and/or other optic elements; one or more focusing mechanisms; and imaging sensor devices that permit capturing both still pictures and motion pictures. The imaging sensor devices can include one or more photodetectors (an array of photodiodes, for example), active amplifiers, and the like. In some embodiments, the imaging sensor devices can be embodied in or can include a semiconductor-based sensor having multiple semiconducting photosensitive elements. For instance, the imaging sensor devices can be embodied in or can include a charge-coupled device (CCD) camera; an active-pixel sensor or other type of complementary metal-oxide semiconductor (CMOS) based photodetector; an array of multi-channel photodiodes; a combination thereof; or the like.

In some scenarios, acquiring the image of the removable tattoo 104 can include generating multiple image frames that can be processed by the mobile device 110 to produce a single image. For instance, the multiple frames can constitute a 360-degree scan of a wearable token, such as the removable tattoo 104, which scan can permit a detailed analysis of the wearable token. Such a scan can be implemented, for example, in embodiments in which the wearable token includes a three-dimensional (3D) structure rather than a slab or another type of essentially planar object.

As is illustrated in FIG. 1, the wearable tattoo 104 can include several markings, e.g., distinct arrangements of visual elements or indicia. Each one of the several markings has a specific structure, including shape and color, for example. One or more of the several markings also can include respective content. Thus, one or more of such markings can have respective semantics. For example, a first marking of the defined markings can include a legend or another type of inscription. As another example, a second marking of the defined markings can include a logo or another type of graphical representation of an entity. In addition, two or more markings can be related to a particular theme and/or a particular live event. The particular live event can include a sports event, a cultural event, a conference, a trade show, a family reunion, a wedding, a birthday celebration, or the like. As an example, the removable tattoo 104 can include first indicia 106a and second indicia 106b related to a specific live event—a Celtic celebration. As is illustrated in FIG. 1, the first indicia 106 includes natural language and the second indicia includes an image. The removable tattoo 104 also can include other types of markings that can personalize the removable tattoo 104. Specifically, such markings include third indicia 106c indicative of a specific function linked to the wearable tattoo 104 (or the bearer thereof). The markings also can include fourth indicia 106d indicative of a unique code linked to the wearable tattoo 104.

Accordingly, upon or after the mobile device 110 acquires the image of the wearable tattoo 104 (or, in some embodiments, another type of wearable token) the mobile device 110 can determine if a group of defined markings is present in the acquired image. The group of defined markings can establish, for example, a specific scope of access to be afforded to the wearable tattoo 104 (or a bearer thereof). The specific scope of access can include, for example, location(s) to which the wearable tattoo is permitted to enter; time period(s) during which the wearable tattoo is permitted to access a defined location; in-and-out privileges in a location; and the like. Various types of locations are contemplated. For instance, the locations can include a loyalty club lounge, backstage at a concert or entertainment event, clubhouse access, and the like.

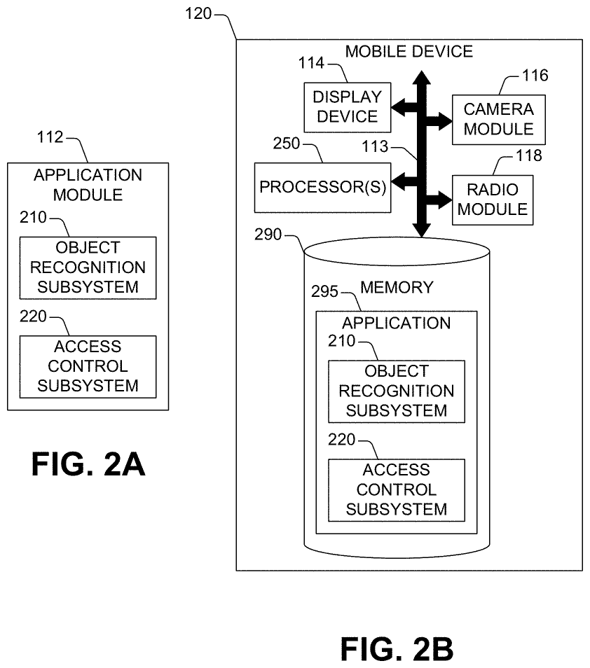

To perform such a determination, the mobile device 110 can execute (or, in some instances, can continue executing) the application retained in the application module 112. In some embodiments, as is illustrated in FIG. 2A, the application module 112 can include an object recognition subsystem 210 that can determine if the group of defined markings are present in the acquired image. The object recognition subsystem 210 constitutes the application resident in the mobile device 110. In other embodiments, as is illustrated in FIG. 2B, the application module 112 can be embodied in computer-accessible instructions can be encoded or otherwise retained in one or more memory devices 290 (generically represented as memory 290). The computer-accessible instructions also can be encoded or otherwise retained in other types of computer-readable non-transitory storage media. The computer-accessible instructions include computer-readable instructions, computer-executable instructions, or a combination of both, that can be arranged in one or more components. The component(s) can be built (e.g., linked and compiled) into an application 295 that can be executed by one or more processors 250 in order to provide the various functions described herein. To that point, the application 295 includes the object recognition subsystem 210.

With further reference to FIG. 1, in one scenario, the application can detect the group of defined markings in the image of the removable tattoo 104 (or another type of wearable token that is imaged in accordance with this disclosure). To detect the group of defined markings the mobile device 110 can execute (or, in some instances, can continue executing) the application to perform one or multiple machine-vision techniques that can identify at least one marking of the defined markings. Such techniques can include, edge detection, segmentation, and the like. In addition, or as an alternative, the mobile device 110 can execute (or, in some instances, can continue executing) the application to apply a machine-learning model to the image of the removable tattoo. The machine-learning model is trained to identify each one of the defined markings. The machine-learning model can be embodied in or can include, for example, a support vector machine (SVM), a regression model (such as a k-nearest neighbor (KNN) model); a neural network (NN), a convolutional neural network (CNN); a region-based CNN (R-CNN); a generative adversarial network (GAN); or the like. Parameters that defined the machine-learning model can be determined (or, in machine-learning parlance, trained) by solving a defined optimization problem, using a training data in a supervised or unsupervised fashion. The training data includes example images of a particular defined marking, such as a legend or inscription; a graphical mark; an emblem; a symbol; a brand name; a band name; an event name; a venue name; a font type; or the like. In some embodiments, as is shown in FIG. 2A and FIG. 2B, the machine-vision technique and/or the machine-learning model can be encoded or otherwise retained in the object recognition subsystem 210.

More specifically, the object recognition subsystem 210 can detect a defined marking (e.g., an arrangement of marks, such as an image or a text) in two-dimensional (2D) images of respective wearable tokens. As mentioned, wearable tokens can be embodied in or can include essentially planar objects or 3D objects having respective morphologies. A morphology of an object includes a shape of the object, a material or combination or materials that constitute the object, and internal structure of the object. The internal structure can include, for example, an arrangement of voids and/or an arrangement of overlays of respective sizes. Similar to other wearable tokens of this disclosure, the morphology can be specific to a live event and/or an intended bearer a wearable token.

The object recognition subsystem 210 can analyze properties of a 2D image to determine (or, in machine-vision parlance, recognize) various properties of the wearable token regardless of the wearable token being essentially planar or non-planar. The properties of the wearable token can include, for example, shape, texture or other structure; color; inscription(s) (and subsequent optical character recognition (OCR)); inscription positioning within the wearable token; images present on the wearable token, scannable codes (e.g., QR codes, bar codes, etc.); non-scannable codes; a combination of the foregoing; and the like.

The object recognition subsystem 210 also can identify a form of three-dimensional wearable token in an image acquired by the mobile device 110, via the camera module 116, for example. Such a 3D reconstruction can be performed by establishing a machine-learning shape model, which can be referred to as a trained feature model. Such a machine-learning shape model can be determined (or, in machine-learning parlance, trained) from training data where the 2D-3D correspondence is known, by estimating parameters that define the shape model. The parameters can be estimated by solving a model-specific optimization problem, for example. More concretely, such a machine-learning shape model can be trained by generating multiple image of a three-dimensional wearable token and determining model parameters using at least such images. More specifically, upon or after acquiring an image of a wearable token that is embodied in a 3D object (e.g., an ornament, a talisman, or another type of small sculpture), the process of identifying a form of the 3D object can include a two-stage process. In a first stage, image features, such as points, curves, and contours, are identified in the images. The features can be identified using various techniques, including Active Shape Models (ASM), gradient-based methods, or classifiers such as SVM. In a second stage, in some embodiments, the form is inferred using a trained feature model. In other embodiments, the second stage can include extending the 3D shape representation from curves and points to a full surface model by fitting a surface to the 3D data.

Without intending to be bound by theory and/or modeling, generation of a feature model is described. Assume a number of elements in a d-dimensional vector t, for example, a collection of 3D points in some normalized coordinate system. The starting point for the derivation of the model is that the elements in t can be related to some latent vector u of dimension q where the relationship is linear:

t=Wu+μ (1)

where W is a matrix of size d×q and μ is a d-vector allowing for non-zero mean. Once the model parameters W and μ have been learned from examples, they are kept fixed. However, measurements take place in the images, which usually is a non-linear function of the 3D features according to the projection model for the relevant imaging device.

Denote the projection function with f: R^{d}→R^{e}, projecting all 3D features to 2D image features, for one or more images. Also, the coordinate system of the 3D features can be changed to suit the actual projection function. Denote this mapping by T: R^{d}→R^{d}. Typically, T is a similarity transformation of the world coordinate system. Thus, f(T(t)) will project all normalized 3D data to all images. Finally, a noise model needs to be specified. Assume that the image measurements are independent and normally distributed, likewise, the latent variables are assumed to be Gaussian with unit variance u˜N(0,I). Thus, in summary:

t_{2D}=ƒ(T(t))+ϵ=ƒ(T(Wu+μ))+ϵ (2)

where ϵ˜N(0, σ² I) for some scalar σ.

Before the model can be used, parameters of the model need to be estimated from training data. Given that it is a probabilistic model, in some embodiments, the parameters can be determined by solving an optimization problem, such as finding a maximum likelihood (ML). Assume n examples {t_{2D,i}}ᵢ₌₁ⁿ, the ML estimate for W and μ is obtained by minimizing:

$${\sum }_{i = 1}^{n} ( \frac{1}{{σ}^{2}} {‖ {t}_{2 D} - f ( {T}_{i} ( {u}_{i} ) ) ‖}^{2} + {‖ {u}_{i} ‖}^{2} \qquad ( 3 )$$

over all unknowns. The standard deviation σ is estimated a priori from the data. After the model parameters W and μ have been learned from examples, they are kept fixed. In practice, to minimize (3) the methods can alternatively optimize over (W, μ) and {uᵢ}ᵢ₌₁ⁿ using gradient descent. Initial estimates can be obtained by intersecting 3D structure from each set of images and then applying PPCA algorithms for the linear part. The normalization Tᵢ(.) is chosen such that each normalized 3D sample has zero mean and unit variance.

There are three different types of geometric features embedded in the model, points, curves, and apparent contours. Points: A 3D point which is visible in m>1 images will be represented in the vector t with its 3D coordinates (X,Y,Z). For points visible in only one image, m=1, no depth information is available, and such points are represented similarly to apparent contour points. Curves: A curve will be represented in the model by a number of points along the curve. In the training of the model, it is important to parameterize each 3D curve such that each point on the curve approximately corresponds to the same point on the corresponding curve in the other examples. Apparent contours: As for curves, we sample the apparent contours (in the images). However, there is no 3D information available for the apparent contours as they are view-dependent. A simple way is to treat points of the apparent contours as 3D points with a constant, approximate (but crude) depth estimate.

Finding Image Features.—In the on-line event of a new input sample, we want to automatically find the latent variables u and, in turn, compute estimates of the 3D features t. The missing component in the model is the relationship between 2D image features and the underlying grey-level (or color) values at these pixels. There are several ways of solving this, e.g. using an ASM (denoted the grey-level model) or detector based approaches.

The Grey-Level Model.—Again, a linear model (PPCA) can be adopted. Using the same notation as in Eq. (1), but now with the subscript gl for grey-level, the model can be written

t_{gl}=W_{gl}u_{gl}+μ_{gl}+ϵ_{gl} (4)

where t_{gl} is a vector containing the grey-level values of all the 2D image features and ϵ_{gl} is Gaussian noise in the measurements. In the training phase, each data sample of grey-levels is normalized by subtracting the mean and scaling to unit variance. The ML-estimate of W_{gl} and μ_{gl} is computed with the EM-algorithm [5].

Detector-Based Methods.—Image interest points and curves can be found by analyzing the image gradient using e.g. the Harris corner-detector. Also, specially designed filters can be used as detectors for image features. By designing the filters so that the response for certain local image structures are high, image features can be found using a 2D convolution.

Classification Methods.—Using classifiers, such as SVM, image regions can be classified as corresponding to a certain feature or not. By combining a series of such classifiers, one for each image feature (points, curves, contours etc.) and scanning the image at all appropriate scales the image features can be extracted. Examples can include, for example, an eye detector for facial images.

Deformable Models.—Using a deformable model such as the Active Contour Models, also called snakes, of a certain image feature is very common in the field of image segmentation. Usually the features are curves. The process is iterative and tries to optimize an energy function. An initial curve is deformed gradually to the best fit according to an energy function that may contain terms regulating the smoothness of the fit as well as other properties of the curve.

Surface Fitting to the 3D Data.—After the 3D data is recovered, a surface model can be fitted to the 3D structure. This might be desirable in case the two-step procedure above only produces a sparse set of features in 3D space such as e.g. points and space curves. Even if these cues are characteristic for a particular sample (or individual), it is often not enough to infer a complete surface model, and in particular, this is difficult in the regions where the features are sparse. Therefore, a 3D surface model consisting of the complete mean surface is introduced. This will serve as a domain-specific, e.g., specific for a certain class of objects, regularizer. This approach requires that there is dense 3D shape information available for some training examples in the training data of the object class obtained from e.g. laser scans or, in the case of medical images, from MRI or computer tomography, for example. From these dense 3D shapes, a model can be built separate from the feature model above. This means that, given recovered 3D shape, in the form of points and curves, from the feature model, the best dense shape according to the recovered 3D shape can be computed. This dense shape information can be used to improve surface fitting.

Regardless of the technique(s) utilized, the detection of the group of defined markings in the image of the removable tattoo 104 (or another type of wearable token that is imaged in accordance with this disclosure) can cause the display device 114 to present information based at least on one or more markings of the group of defined markings. The information presented by the display device 114 can permit or otherwise facilitate identifying a bearer of the removable tattoo 104 (or another type of wearable token that is imaged in accordance with aspects of this disclosure). In addition, or in other instances, the information can permit or otherwise facilitate controlling access to a specific area. As is illustrated in FIG. 1, the display device 114 can present a UI 120b having a group of visual elements 126 that convey the information. In addition, or in other embodiments, the mobile device 110 can present aural elements that convey at least some of the information. To that end, the mobile device 110 can include an audio output module (not depicted in FIG. 1).

The information that is presented by the display device 114 can be generated or otherwise accessed in multiple ways. In some embodiments, the mobile device 110 can execute (or, in some instances, can continue executing) the application retained in the application module 112 to generate the information. To that end, in one example, the application can generate the information by applying access control logic to the one or more markings that are detected on an image of the removable tattoo 104 (or another type of wearable token). Again, with reference to FIG. 2A, in some embodiments, the application module 112 can include an access control subsystem 220 that can apply the access control logic. The access control subsystem 220 constitutes the application resident in the mobile device 110. In other embodiments, as is illustrated in FIG. 2B, the application module 112 can be embodied in computer-accessible instructions encoded or otherwise retained in the memory 290. The computer-accessible instructions also can be encoded or otherwise retained in other types of computer-readable non-transitory storage media. As mentioned, the computer-accessible instructions include computer-readable instructions, computer-executable instructions, or a combination of both, that can be arranged in one or more components. The component(s) can be built (e.g., linked and compiled) into the application 295 that can be executed by the processor(s) 270 in order to provide the various functions described herein. To that point, the application 295 includes the object recognition subsystem 210 and the access control subsystem 220.

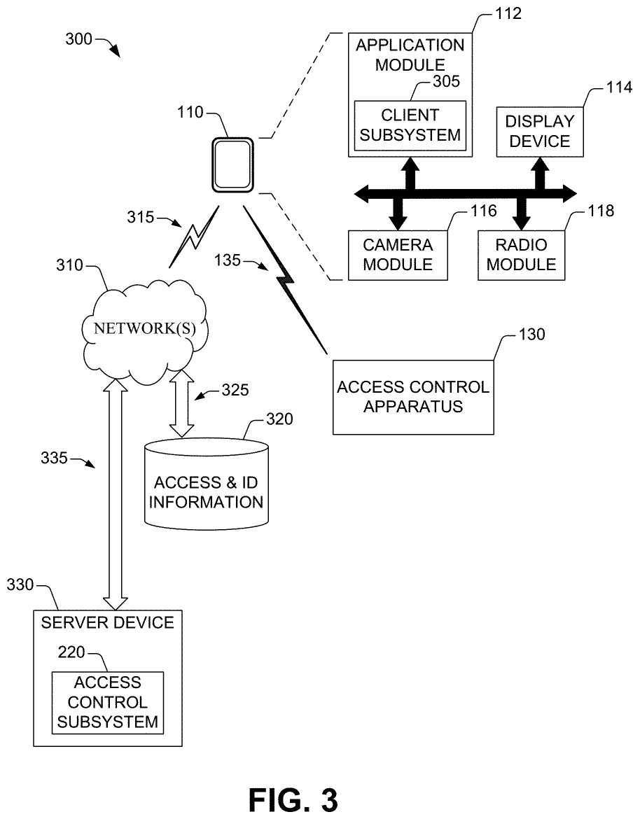

The access control logic can include one or more access rules and can be retained in one or more memory devices (not depicted in FIG. 1) integrated into the mobile device 110. For instance, a first access control rule can dictate that a name and/or a picture of an individual identified by a marking detected in the removable tattoo be accessed. As such, the application can apply the first access rule to each of the markings in the detected group of markings. As a result, the application can access the name and/or imaging data indicative of a picture of the individual when a first markings identifies the individual. More concretely, as an illustration, in connection with the removable tattoo 104, the application can access a name and a picture from the fourth indicia 106d. Thus, by applying the first access rule, the application can cause the display device 114 to present the name (e.g., Joe B. Sepz) and picture. Accordingly, the visual elements 126 can include elements that convey the name and also can include the picture. To access such information, in some embodiments, as is illustrated in FIG. 3, the application module 112 can generate a query message requesting the name and picture. The application module 112 can send the query message to a database 320 that contains access and identification (ID) information. The database 320 can send a response message to the query message, to the application module 112, where the response message can include the name and picture.

As is further illustrated in FIG. 3, one or more networks 310 can permit or otherwise facilitate the exchange of the query and response messages and related information between the mobile device 110 and the database 320. To that, at least one of the network(s) 310 can functionally couple the mobile device 110 and the database 320. Such a coupling can be permitted or otherwise facilitated by wireless links 315 and a communication architecture 325. The communication architecture 325 can include upstream links (ULs) and downstream links (DLs). Each one of the ULs and the DLs can be embodied in or can include a wireless link (e.g., deep-space wireless links and/or terrestrial wireless links), a wireline link (e.g., optic-fiber lines, coaxial cables, and/or twisted-pair lines), or a combination thereof. It is noted that while illustrates as separate elements, portions of the communication architecture 325 can be integrated into one or more of the network(s) 310.

The network(s) 310 can include wireline network(s), wireless network(s), or a combination thereof. Each one of the networks that can constitute the network(s) 310 has a defined footprint. As such, the network(s) 310 can include public networks, private networks, wide area networks (e.g., Internet), local area networks, and/or the like. The network(s) 310 can include a packet switched network (e.g., internet protocol based network), a non-packet switched network (e.g., quadrature amplitude modulation based network, plain old telephone system (POTS)), a combination thereof and/or the like. The network(s) 310 can include numerous types of devices, such as network adapter devices, switch devices, router devices, modems, and the like functionally coupled through wireless links (e.g., cellular, radio frequency, satellite) and/or wireline links (e.g., fiber optic cable, coaxial cable, Ethernet cable, or a combination thereof). The network 310 can be configured to provide communication from telephone, cellular, modem, and/or other devices to and throughout the operational environment 300.

Further, or in another example, a second access rule can dictate that information indicative of a locale be accessed for a specific function conveyed by a detected marking. As such, the application retained in the application module 112, when executed, can apply the second rule to each of the markings in a detected group of markings. As a result, the application can access the information indicative of the locale when a first marking identifies a particular function or role. More concretely, in connection with the removable tattoo 104, the application can access location information in response to the third indicia 106d. Such indicia, as mentioned, can link the removable tattoo 104 to a “Bouncer” role. Thus, by applying the second access rule, the application can cause the display device 114 to present information indicative of a location within a venue where the bearer of the removable tattoo 104 is to serve as a bouncer. Accordingly, the visual elements 126 can include elements that convey the location within the venue. Again, to access such information, as is illustrated in FIG. 3, the application module 112 can generate a query message requesting such location information. The application module 112 can send the query message to the database 320. The database 320 can send a response message to the query message, to the application module 112, where the response message can include the location information. As mentioned, one or more networks 310 can permit or otherwise facilitate the exchange of the query and response messages and related information between the mobile device 110 and the database 320.

Therefore, the application retained in the application module 112 can cause the display device 110 to present a name, a picture, and location information in response to applying the first and second access rules to markings including third indicia 106 and fourth indicia 106d. The information present at the display device 114 can permit or otherwise facilitate corroborating that the bearer of the removable tattoo 104 is legitimate and is directed to an appropriate locale.

The access control subsystem 220 (see FIG. 2A and FIG. 2B) need not be configured in the mobile device 110. Instead, in some embodiments, the access control subsystem 220 can be installed or otherwise configured in a server device separate from the mobile device 110. In such embodiments, the mobile device 110 can include a client subsystem that can communicate with the access control subsystem 220 within the other device.

With further reference to FIG. 3, the operational environment 300 includes such a server-client configuration. At least one of the network(s) 310 can functionally couple the mobile device 110 and a server device 330. Such a coupling can be permitted or otherwise facilitated by the wireless links 315 and a communication architecture 335. The communication architecture 335 can include upstream links (ULs) and downstream links (DLs). Each one of the ULs and the DLs can be embodied in or can include a wireless link (e.g., deep-space wireless links and/or terrestrial wireless links), a wireline link (e.g., optic-fiber lines, coaxial cables, and/or twisted-pair lines), or a combination thereof. It is noted that while illustrates as separate elements, portions of the communication architecture 325 can be integrated into one or more of the network(s) 310.

An application included in the application module 112 can detect a group of defined markings in an image of the removable tattoo 104 (or another type of wearable token). The application can send information indicative of the group of defined markings to the access control subsystem 220. The information can be sent via at least one first network of the network(s) 310.

The access control subsystem 220 can receive the information and can apply access control logic in accordance with various aspects of this disclosure. As a result, the access control system 220 can send access control information to a client subsystem 305. The access control information can be sent via the at least one first network. The client subsystem 305 can be included in the application retained in the application module 112. In response to receiving the access control information, the client subsystem 305 can cause the display device 114 to present at least a portion of the access control information. To that point, as mentioned, the display device 114 can present the UI 120b including visual elements 126 that convey at least the portion of the access control information.

Detection of a group of defined markings in the image of the removable tattoo 104 (or another type of wearable token that is imaged) can cause the mobile device 110 to implement additional or different responses besides displaying information. In some embodiments, with further reference to FIG. 1, the mobile device 110 can cause an access control apparatus 130 to perform a specific operation based at least on one or more of the group of defined markings that is detected. Such an operation can correspond to a specific functionality of the access control apparatus 130. In one instance, the operation can be performed in response to a first marking of the group of defined marking being indicative of a sanctioned live event (e.g., Celtic celebration) or a sanctioned function (e.g., bouncer). In another instance, the operation can be performed in response to first and second markings of the group of defined marking being indicative, respectively, of a validated identity and a sanctioned function. For example, the access control apparatus 130 can be embodied in or can include an automated gate apparatus, and the specific operation can be opening the gate. A gate of such an apparatus can be opened in response to the mobile device 110 detecting the graphical mark in the second indicia 106b and the function conveyed by the third indicia 106d. In other words, the mobile device 110 can determine that the removable tattoo 104 is linked to a bouncer for the 3rd Annual Celtic Celebration and can cause the gate to open.

Thus, in sharp contrast to commonplace technologies for controlling access, embodiments of the subject disclosure provide identification and access control without reliance on expensive devices (carried by an end-user or deployed at a control point). Thus, in further contrast, embodiments of the disclosure can provide identification and access control in environments where it may be impractical or undesirable to carry mobile devices or other consumer electronics.

Regardless the architecture and functionality of the access control apparatus 130, the mobile device 110 can send an instruction to perform the specific operation. The instruction can be formatted or otherwise configured according to a control protocol for the operation of actuators, switches, motors, and the like. The control protocol can include, for example, modbus; Ethernet-based industrial protocol (e.g., Ethernet TCP/IP encapsulated with modbus), controller area network (CAN) protocol; profibus protocol; and/or other types of fieldbus protocols.

The instruction can be sent wirelessly via at least a wireless upstream link (uplink (UL)) included in wireless links 135. To that end, the mobile device can include a radio module 118 than can send the instruction according to a defined radio technology protocol for point-to-point or short-range wireless communication. More specifically, the radio module 118 can include one or more antennas and processing circuitry that permit communicating wirelessly in accordance with the defined radio technology protocol. Thus, the radio module 118 is configured to wireless signals according to one or several radio technology protocols including ZigBee™; Bluetooth™; near field communication (NFC) standards; ultrasonic communication protocols; or the like. The antenna(s) and processing circuitry also can permit the radio module 118 to communicate wirelessly according to other radio technology protocols, including protocols for small-cell wireless communication and macro-cellular wireless communication. Such protocols include IEEE 802.11a; IEEE 802.1 lax; 3rd Generation Partnership Project (3GPP) Universal Mobile Telecommunication System (UMTS) or “3G;” fourth generation (4G); fifth generation (5G); 3GPP Long Term Evolution (LTE); LTE Advanced (LTE-A); wireless broadband (WiBro); and the like.

As mentioned, in some embodiments, a wearable token can be embodied in a 3D object, such as a garment, an ornament, a talisman, a small sculpture, or another type of custom-made 3D object. Some 3D objects also can include other features, such as colors, patterns, and the like. The 3D objects can be formed by means of 3D printing, machining, molding, or other manufacturing techniques. In such embodiments, the mobile device 100 can identify a form of the 3D object; e.g., a bottle, an automobile, a guitar, an emblem, a butterfly, a fairy, a dog, a jack-o-lantern effigy, a pig effigy, and the like. In instances in which the identified form matches a defined form of a reference object, the mobile device 110 can cause the display device 115 to present information in accordance with aspects described herein.

Further, or in some instances, a 3D wearable token can include markings (e.g., characters in relief) representative of a legend, for example. In addition, or as an alternative, the 3D wearable token can include structural features, such as a particular arrangement of overlays (e.g., an array of colored pieces) or a pattern of colors. The mobile device 110 can detect such markings and/or structural features in addition to determining a 3D shape of the 3D wearable token. In response to such a detection, the mobile device 110 can cause the display device 112 to present specific information in accordance with aspects of this disclosure. In addition, or in other instances, the mobile device 110 also can cause the access control apparatus 130 to perform one or more defined operations.

As an illustration, the 3D wearable token can include a small sculpture of a labradoodle dog and an inscription that reads “Ginger N” The mobile device 110 can be utilized at a kennel or boarding facility where the application module 112, via the object recognition 210, for example, can detect such an inscription and shape on the 3D wearable token. In response, the mobile device 110 can cause a display device 112 to present confirmation information that a labradoodle named “Ginger,” with last name initial “N” is scheduled for an overnight stay, and also can present a picture of Ginger. Based on such a determination, the mobile device 110 can cause a variable-sign display apparatus to present visual elements indicative of a kennel room assigned to such a dog and a location of the kennel room within the boarding facility. Further based on such a determination, the mobile device 110 can cause a lock device on a door of the kennel room to become unlocked. Both the variable sign-display and the lock device can constitute the access control apparatus 130.

In some scenarios, the application module 112 (via, for example, the object recognition subsystem 210, FIG. 2A and FIG. 2B) can determine that the group of defined markings is absent from the acquired image of the removable tattoo 104 (or another type of wearable token that is imaged). In response, the mobile device 110 can perform an exception handling process. In some embodiments, as part of performing the exception handing process, the mobile device 110 can cause the display device 114 to present information indicative of the wearable token being in a fault state. As an example, the fault state can represent a denial of access to a facility or another type of premises. Such information can be retained in one or more memory devices (not depicted in FIG. 1) integrated into the mobile device 110. Specifically, the display device 114 can present a UI 120c having a group of visual elements 128 (text, graphics, etc.) indicative of such information. In addition, or in other embodiments, the mobile device 110 can present a group of aural elements (e.g., utterances or other types of sound) that convey the at least some of the information indicative of the fault-state.

In the foregoing embodiments disclosed in connection with mobile device 110, a communication interface 113 functionally couples the modules, devices, and other components included in the mobile device 110. The communication interface 113 permits the transmission, reception, and exchange of data, metadata, signaling, within the mobile device 110. As such, the communication interface 113 be embodied in or can include, for example, one or more bus architectures or other wireline or wireless connections. One or more of the bus architectures can include an industrial bus architecture, such as an Ethernet-based industrial bus, a controller area network (CAN) bus, a Modbus, other types of fieldbus architectures, or the like. The communication interface 113 can have additional elements, which are omitted for simplicity, such as controller device(s), buffer device(s) (e.g., caches), drivers, repeaters, transmitter device(s), and receiver device(s), to enable communications. Further, the communication interface 716 may include address, control, and/or data connections to enable appropriate communications among the aforementioned components.

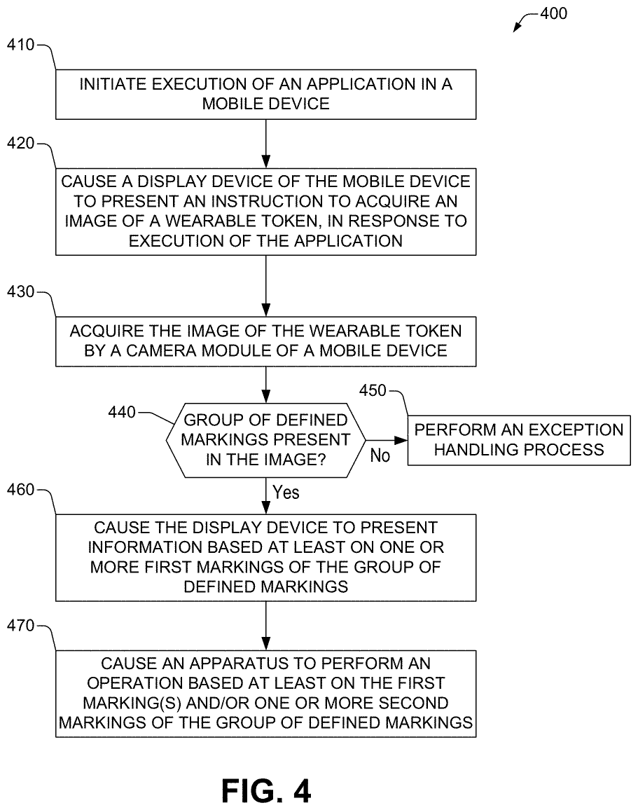

In view of various aspects described herein, examples of the techniques that can be implemented in accordance with this disclosure can be better appreciated with reference to FIGS. 4-6. Specifically, FIG. 4 illustrates a flowchart of an example of a method 400 for providing identification and controlling access using a wearable token, in accordance with one or more embodiments of this disclosure. As mentioned, the wearable token can be embodied in or can include, for example, a removable tattoo, a patch (e.g., a piece of cloth mounted or otherwise sewed to a garment) a sports event bib, an admission badge, or the like. As another example, the wearable token can be embodied in or can include a 3D solid object, such as a wristband, an ornament, a talisman, a garment, or the like. A mobile device having a camera module (e.g., camera module 116) and computing resources can implement at least part of the example method 400. The computing resources include one or more processors (e.g., processor(s) 250) or other types of processing circuitry; one or more memory devices (e.g., memory 290) or other types of storage circuitry; input/output (I/O) interfaces; a combination thereof; or the like. In some embodiments, the mobile device is embodied in or includes the mobile device 110.

At block 410, the mobile device can initiate execution of an application resident in the mobile device. The application can be installed in the mobile device as either hardware or software. As is disclosed herein, in hardware, the application can be embodied in or can constitute a dedicated integrated circuit (e.g., an ASIC or a FPGA). At block 420, in response to execution of the application, the mobile device can direct or otherwise cause a display device to present an instruction to acquire an image of the wearable token. The display device can be integrated into the mobile device or otherwise can be functionally coupled to the mobile device.

At block 430, the mobile device can acquire the image of the wearable token by means of the camera module integrated into the mobile device. At block 440, the mobile device can determine if a group of defined markings are present on the image of the wearable token. As is disclosed herein, at least one marking of the group of defined markings can have respective particular semantics. For example, a first marking of the defined markings can include a legend another type of inscription. As another example, a second marking of the defined markings can include a logo or another type of mark representative of an entity or a live event.

In some embodiments, determining if the group of defined markings are present on the image of the wearable token can include performing one or multiple machine-vision technique that can identify at least one marking of the group of defined markings. In addition, or in other embodiments, determining if the group of defined markings are present on the image of the wearable token can include applying a machine-learning model to the image. The machine-learning model is trained to identify each (or, in some instances, at least one) marking of the group of defined markings.

In some scenarios, the mobile device can determine that the group of defined markings is absent from the image of the wearable token (“No” branch in FIG. 4). In response, flow of the example method 400 can continue to block 450, at which block the mobile device can perform an exception handling process. As mentioned, in some embodiments, performing the exception handling can include causing the display device to present information indicative of the wearable token being in a fault state. The fault state can include, for example, an access-denied state in connection with access to a facility or another type of premises. Such information can be conveyed with a group of visual elements (text, images, etc.) and/or a group of aural elements (e.g., utterances or other types of sound).

In the alternative, flow of the example method 400 can continue to block 460 in response to the mobile device detecting the group of the defined markings on the image (“Yes” branch in FIG. 4). At block 460, the mobile device can cause the display device to present information based at least on one or more first markings of the group of defined markings. Presenting the information can include, for example, presenting a group of visual elements indicative of an identify linked to the wearable token. The identity can be encoded or otherwise represented by a particular marking of the defined markings. In one example, the particular marking can include a unique string of alphanumeric characters (e.g., fourth indicia 106d, FIG. 1). In addition, or in other embodiments, presenting the information can include presenting a group of visual elements indicative of a location within a venue. The location can correspond to a role (e.g., runner, bouncer, musician, VIP attendee, etc.) linked to the wearable token.

At block 470, the mobile device can cause an apparatus to perform an operation based at least on the first marking(s) and/or one or more second markings of the group of defined markings. The apparatus can have a specific functionality and the operation can correspond to a function included in the specific functionality. Such functionality is particular to the architecture of the apparatus, e.g., a display apparatus, an automated locking apparatus, an automated gate apparatus, and the like. The apparatus can be embodied in or can include the access control apparatus 130. As is disclosed herein, in some embodiments, the mobile device can send an instruction wirelessly to the apparatus to direct the apparatus to perform the operation. The instruction can be formatted or otherwise configured according to a control protocol that permits of otherwise facilitates the automation control of the apparatus. Again, the control protocol can include various types of fieldbus protocols.

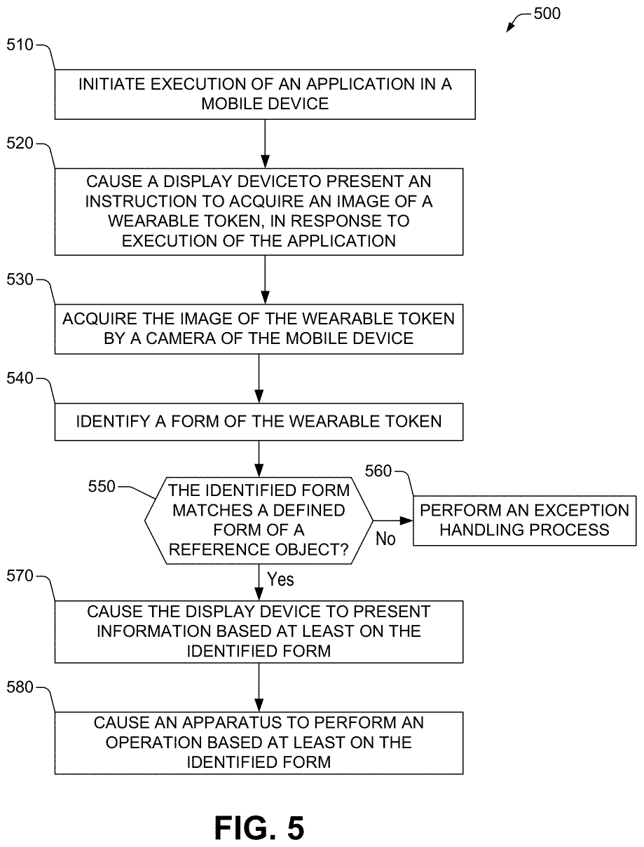

FIG. 5 illustrates a flowchart of an example method 500 for providing identification and controlling access using a wearable token, in accordance with one or more embodiments of this disclosure. The wearable token can be embodied in or can include a three-dimensional solid object, such as a wristband, an ornament, a garment, or the like. A mobile device having a camera module (e.g., camera module 116) and computing resources can implement at least part of the example method 200. The computing resources include one or more processors (e.g., processor(s) 250) or other types of processing circuitry; one or more memory devices (e.g., memory 290) or other types of storage circuitry; input/output (I/O) interfaces; a combination thereof; or the like. In some embodiments, the mobile device is embodied in or includes the mobile device 110.

At block 510, the mobile device can initiate execution of an application resident in the mobile device. The application can be installed in the mobile device as either hardware or software. Again, in hardware, the application can be embodied in or can constitute, for example, an ASIC, a FPGA, or another type of dedicated integrated circuit. At block 520, in response to execution of the application, the mobile device can cause a display device to present an instruction to acquire an image of a wearable token. As mentioned, in some embodiments, the display device can be integrated into the mobile device.

At block 530, the mobile device can acquire the image of the wearable token by means of a camera module integrated into the mobile device. At block 540, the mobile device can identify a form of the wearable token. To that end, in some embodiments, the mobile device can detect geometrical features of the wearable token. As mentioned, the geometrical features can include edges (straight, nearly straight, and/or curved), vertices, apparent contours, and the like. The mobile device can identify the form of the wearable token using at least the geometrical features. In some embodiments, the mobile device can infer a form (e.g., a 3D shape) corresponding to the image features. To that end, the mobile device can apply a statistical shape model in accordance with aspects of this disclosure. Such a model can be applied by executing the object recognition subsystem 210.

At block 550, the mobile device can determine if the identified form matches a defined form of a reference object. For instance, the mobile device can determine if the identified form satisfies one or more matching criteria relative to the reference object. In response to a negative determination (“No” branch in FIG. 5) the flow of the example method 500 continues to block 560, at which block the mobile device can perform an exception handling process. As mentioned, in some embodiments, performing the exception handling can include causing the display device to present information indicative of the wearable token being in a fault state. The fault state can include, for example, an access-denied state in connection with access to a facility or another type of premises. Such information can be conveyed with a group of visual elements (text, images, etc.) and/or a group of aural elements (e.g., utterances or other types of sound).

In the alternative, flow of the example method 500 continues to block 570 in response to an affirmative determination at block 550 (“Yes” branch in FIG. 5). At block 570, the mobile device can cause the display device to present information based at least on the identified form (e.g., identified shape and/or identified structure).

At block 580, the mobile device can cause an apparatus to perform an operation based at least on the identified form. Again, the apparatus can have a specific functionality and the operation can correspond to a function included in the specific functionality. Such functionality is particular to the architecture of the apparatus, e.g., a display apparatus, an automated locking apparatus, an automated gate apparatus, and the like. The apparatus can be embodied in or can include the access control apparatus 130. As is disclosed herein, in some embodiments, the mobile device can send an instruction wirelessly to the apparatus to direct the apparatus to perform the operation. The instruction can be sent via a radio module (e.g., radio module 118) having one or more antennas and processing circuitry that permits sending wireless signals. As mentioned, such an instruction can be formatted or otherwise configured according to a control protocol that permits of otherwise facilitates the automated operation of the apparatus.

The respective techniques illustrated by the example method 400 shown in FIG. 4 and the example method 400 shown in FIG. 5 can be combined. Such a combination results in another technique that can be applicable to wearable tokens having various kinds of markings in addition to a particular morphology.

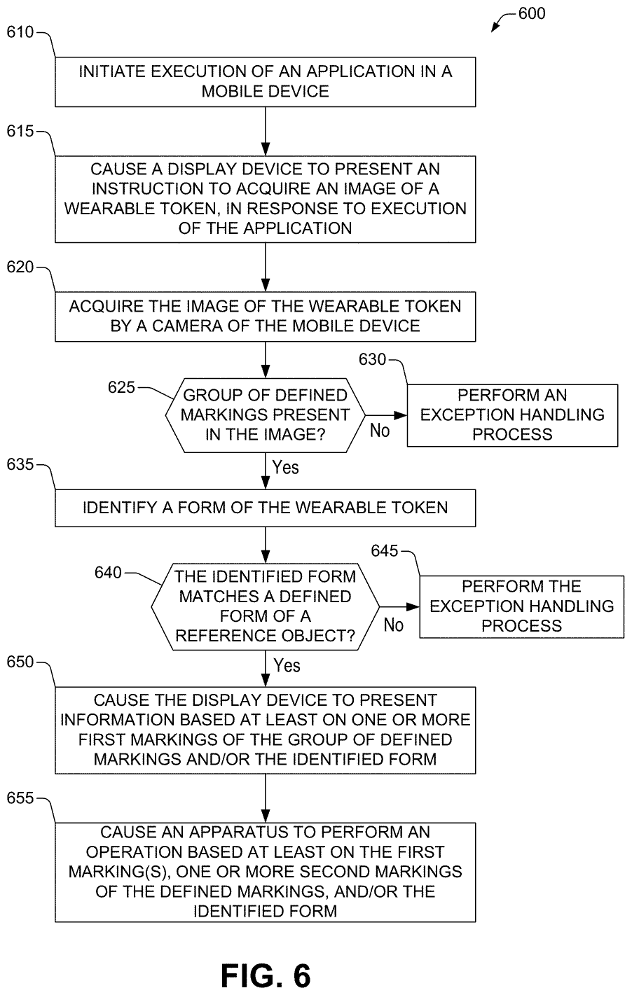

More concretely, FIG. 6 presents a flowchart of an example method 600 that exemplifies the technique that results from the aforementioned combination. As mentioned, a mobile device having a camera module and computing resources can implement at least part of the example method 600. Again, the computer resources include one or more processor or other types of processing circuitry; one or more memory devices or other types of storage circuitry; I/O interfaces; a combination thereof; or the like. In some embodiments, the mobile device is embodied in or includes the mobile device 110.

At block 610, the mobile device can initiate execution of an application resident in the mobile device. The application can be installed in the mobile device as either hardware or software. At block 615, in response to execution of the application, the mobile device can direct or otherwise cause a display device to present an instruction to acquire an image of a wearable token. The display device can be integrated into the mobile device or otherwise can be functionally coupled to the mobile device.

At block 620, the mobile device can acquire the image of the wearable token by means of a camera module (e.g., camera module 116) integrated into the mobile device. At block 625, the mobile device can determine if a group of defined markings are present in the image of the wearable token. As is disclosed herein, at least one marking of the defined markings can have a particular semantics. As is disclosed herein, in some embodiments, determining if the group of defined markings are present on the image of the wearable token can include performing one or multiple machine-vision technique that can identify at least one marking of the group of defined markings. In addition, or in other embodiments, determining if the group of defined markings are present on the image of the wearable token can include applying a machine-learning model to the image. The machine-learning model is trained to identify each (or, in some instances, at least one) marking of the group of defined markings.

In some scenarios, the mobile device can determine that the group of defined markings is absent from the image of the wearable token (“No” branch in FIG. 6). In response, flow of the example method 600 can continue to block 630, at which block the mobile device can perform an exception handling process.

In the alternative, flow of the example method 600 can continue to block 635 in response to the mobile device detecting the group of the defined markings on the image (“Yes” branch in FIG. 6). At block 650, the mobile device can identify a form of the wearable token. To that end, in some embodiments, the mobile device can detect geometrical features of the wearable token. As mentioned, the geometrical features can include edges (straight, nearly straight, and/or curved), vertices, apparent contours, and the like. The mobile device can identify the form of the wearable token using at least the geometrical features. In some embodiments, the mobile device can infer a form (e.g., a 3D shape) corresponding to the image features. To that end, the mobile device can apply a statistical shape model. Such a model can be applied by executing the object recognition subsystem 210.

At block 650, the mobile device can determine if the identified form matches a defined form of a reference object. For instance, the mobile device can determine if the identified form satisfies one or more matching criteria relative to the reference object. In response to a negative determination (“No” branch in FIG. 6) the flow of the example method 600 continues to block 670, at which block the mobile device can perform an exception handling process.

In the alternative, flow of the example method 600 continues to block 650 in response to an affirmative determination (“Yes” branch in FIG. 6). At block 650, the mobile device can cause the display device to present information based at least on one or more first markings of the group of defined markings and/or the identified form (e.g., identified shape and/or identified structure). As mentioned, presenting the information can include, for example, presenting a group of visual elements indicative of an identify linked to the wearable token. The identity can be encoded or otherwise represented by a particular marking of the defined markings. In addition, or in other embodiments, presenting the information can include presenting a group of visual elements indicative of a location within a venue. The location can correspond to a role (e.g., runner, bouncer, musician, VIP attendee, etc.) linked to the wearable token.

At block 655, the mobile device can cause an apparatus to perform an operation based at least on the first marking(s), one or more second markings of the group of defined markings, and/or the identified form. As is disclosed herein, the apparatus can have a specific functionality and the operation can correspond to a function included in the specific functionality. Such functionality is particular to the architecture of the apparatus, e.g., a display apparatus, a locking apparatus, a gate apparatus, and the like. The apparatus can be embodied in or can include the access control apparatus 130. In some embodiments, the mobile device can send an instruction wirelessly to the apparatus to direct the apparatus to perform the operation. The instruction can be formatted or otherwise configured according to a control protocol that permits of otherwise facilitates the automation control of the apparatus. Again, the control protocol can include various types of fieldbus protocols.

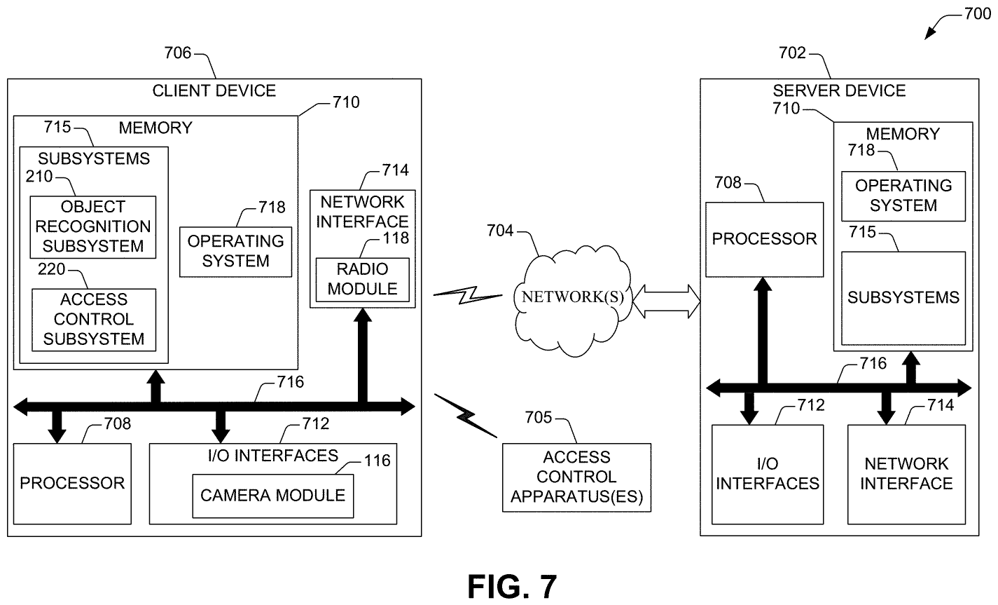

FIG. 7 illustrates an example of a computing environment 700 including examples of a server device 702 and a client device 706 (e.g., mobile device 110) mutually functionally coupled by means of one or more networks 704, such as the Internet or any wireline or wireless connection. The server device 702 and the client device 706 can be a digital computer that, in terms of hardware architecture, can include one or more processor 708 (generically referred to as processor 708), one or more memory devices 710 (generically referred to as memory 710), input/output (I/O) interfaces 712, and network interfaces 714. These components (708, 710, 712, and 714) are communicatively coupled via a communication interface 716. The communication interface 716 can be embodied in or can include, for example, one or more bus architectures or other wireline or wireless connections. One or more of the bus architectures can include an industrial bus architecture, such as an Ethernet-based industrial bus, a controller area network (CAN) bus, a Modbus, other types of fieldbus architectures, or the like. The communication interface 716 can have additional elements, which are omitted for simplicity, such as controller device(s), buffer device(s) (e.g., caches), drivers, repeaters, transmitter device(s), and receiver device(s), to enable communications. Further, the communication interface 716 may include address, control, and/or data connections to enable appropriate communications among the aforementioned components.

The processor 708 can be a hardware device that includes processing circuitry that can execute software, particularly that stored in the memory 710. In addition, or as an alternative, the processing circuitry can execute defined operations besides those operations defined by software. The processor 708 can be any custom made or commercially available processor, a central processing unit (CPU), a graphical processing unit (GPU), an auxiliary processor among several processors associated with the server device 702 and the client device 706, a semiconductor-based microprocessor (in the form of a microchip or chipset), or generally any device for executing software instructions or performing defined operations. When the server device 702 or the client device 706 is in operation, the processor 708 can be configured to execute software stored within the memory 710, for example, in order to communicate data to and from the memory system 710, and to generally control operations of the server device 702 and the client device 706 according to the software.

The I/O interfaces 712 can be used to receive user input from and/or for providing system output to one or more devices or components. User input can be provided via, for example, a keyboard, a touchscreen display device, a microphone, and/or a mouse. System output can be provided, for example, via the touchscreen display device or another type of display device. I/O interfaces 712 can include, for example, a serial port, a parallel port, a Small Computer System Interface (SCSI), an infrared (IR) interface, an radiofrequency (RF) interface, and/or a universal serial bus (USB) interface.

The network interface 714 can be used to transmit and receive data, metadata, and/or signaling from an external server device 702, an external client device 706, and other types of external apparatuses on one or more of the network(s) 704. The network interface 714 also permits transmitting data, metadata, an/or signaling to access control apparatus(es) 705 and receiving other data, metadata, and/or signaling from the access control apparatus(es). The network interface 714 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. Accordingly, as is illustrated in FIG. 7, the network interface 714 in the client device 706 can include the radio module 118. The network interface 714 may include address, control, and/or data connections to enable appropriate communications on the network(s) 704.

The memory 710 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 710 may incorporate electronic, magnetic, optical, and/or other types of storage media. In some embodiments, the memory 710 can have a distributed architecture, where various storage devices are situated remotely from one another, but can be accessed by the processor 708.

Software that is retained in the memory 710 may include one or more software components, each of which can include an ordered listing of executable instructions for implementing logical functions. In the example of FIG. 7, the software in the memory 710 of the server device 702 can include one or more of the subsystems 715 and an operating system (O/S) 718. Similarly, in the example of FIG. 7, the software in the memory 710 of the client device 706 can include one or more of the subsystems 715 and a suitable operating system (O/S) 718. The O/S 718 essentially controls the execution of other computer programs, such as the 0/S 718, and provides scheduling, input-output control, file and data management, memory management, and communication control and related services.

For purposes of illustration, application programs and other executable program components such as the operating system 718 are illustrated herein as discrete blocks, although it is recognized that such programs and components can reside at various times in different storage components of the server device 702 and/or the client device 706. An implementation of the subsystems 715 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the technologies (e.g., techniques, computer program products, devices, and systems) of this disclosure have been described in connection with various embodiments and specific examples, it is not intended that the scope be limited to the particular embodiments put forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
initiating, by a mobile device, execution of an application that presents an instruction to acquire an image of a wearable token, the application installed in the mobile device;
acquiring the image of the wearable token by a camera module included in the mobile device;
detecting, by the mobile device, a group of defined markings on the image of the wearable token, a first marking of the group of defined markings has specific semantics; and
causing, by the mobile device, an apparatus to perform a defined operation in response to at least the first marking, the apparatus is remotely located relative to the mobile device.

2. The method of claim 1, wherein a second marking of the group of defined markings encodes an identity linked to the wearable token, the method further comprising causing a display device to present the identity.

3. The method of claim 1, wherein the acquiring comprises one of acquiring the image of a removable tattoo; acquiring the image of a patch; acquiring the image of a t-shirt; acquiring the image of a sports event bib; or acquiring the image of an admission badge.

4. The method of claim 1, wherein the detecting comprises applying a machine-learning model to the image, the machine-learning model trained to identify a first marking of the defined markings.

5. The method of claim 1, wherein the application presents a second instruction to acquire an image of a second wearable token comprising a three-dimensional (3D) solid object, the method further comprising acquiring an image of the second wearable token by the camera module;
determining that a form of the 3D solid object corresponds to a defined form of a reference object; and
causing, by the mobile device, the apparatus to perform a second defined operation.

6. The method of claim 5, wherein the determining comprises,
detecting geometrical features on the image of the 3D solid object;
identifying the form of the 3D solid object based at least on the one or more geometrical features; and
determining that the form satisfies a matching criterion with respect to the defined form of the reference object.

7. The method of claim 6, wherein the identifying comprises applying a machine-learning shape model to the one or more geometrical features.

8. A mobile device, comprising:
a camera module;
at least one memory device having instructions stored thereon; and
at least one processor functionally coupled to the at least one memory device and configured to execute the instructions at least to
initiate execution of an application that presents an instruction to acquire an image of a wearable token, the application installed in the mobile device;
cause the camera module to acquire the image of the wearable token;
detect a group of defined markings on the image of the wearable token, a first marking of the group of defined markings has specific semantics; and
cause an apparatus to perform a defined operation in response to at least the first marking, the apparatus is remotely located relative to the mobile device.

9. The mobile device of claim 8, wherein a second marking of the group of defined markings encodes an identity linked to the wearable token, and wherein the at least one processor is further configured to execute the instructions to cause a display device to present the identity.

10. The mobile device of claim 8, further comprising a radio module including circuitry to send wireless signals, wherein to cause the apparatus to perform the defined operation, the at least one processor being further configured to cause the radio module to send an instruction to perform the defined operation, and wherein the apparatus comprises one of an automated gate apparatus or a variable-message sign apparatus.

11. The mobile device of claim 8, wherein to detect the group of defined markings, the at least one processor is further configured to execute the instructions to perform a machine-vision technique that identifies a second marking of the group of defined markings.

12. The mobile device of claim 8, wherein to detect the group of defined markings, the at least one processor is further configured to apply a machine-learning model to the image, the machine-learning model trained to identify a second marking of the defined markings.

13. The mobile device of claim 8, the at least one processor further configured to execute the instructions at least to,
cause the camera module to acquire an image of a second wearable token;
determine that a form of the second wearable token corresponds to a defined form of a reference object; and
cause the apparatus to perform a second defined operation.

14. The mobile device of claim 13, wherein to determine that the form of the second wearable token corresponds to the defined form of the reference object, the at least one processor is further configured at least to,
detect geometrical features on the image of the second wearable token;
identify the form of the second wearable token based at least on the one or more geometrical features; and
determine that the form satisfies a matching criterion with respect to the defined form.

15. At least one computer-readable storage device having instructions stored thereon that, in response to execution, cause at least one processor to perform or facilitate operations comprising:
initiating execution of an application that presents an instruction to acquire an image of a wearable token, the application installed in the mobile device;
acquiring the image of the wearable token by a camera module integrated into mobile device;
detecting a group of defined markings on the image of the wearable token, a first marking of the group of defined markings has specific semantics; and
causing an apparatus to perform a defined operation in response to at least the first marking, the apparatus is remotely located relative to the mobile device.

16. The at least one computer-readable storage device of claim 15, wherein a second marking of the group of defined markings encodes an identity linked to the wearable token, the operations further comprising causing a display device to present visual elements indicative of an identity linked to the wearable token.

17. The at least one computer-readable storage device of claim 15, wherein the causing comprises causing a radio module integrated into the mobile device to send wirelessly an instruction to perform the defined operation, and wherein the instruction is configured according to a control protocol for automated operation of the apparatus.

18. The at least one computer-readable storage device of claim 15, wherein the detecting comprises performing a machine-vision technique that identifies a first marking of the defined markings.

19. The at least one computer-readable storage device of claim 15, wherein the detecting comprises applying a machine-learning model to the image, the machine-learning model trained to identify a first marking of the defined markings.

20. The at least one computer-readable storage device of claim 15, wherein the application presents a second instruction to acquire an image of a second wearable token comprising a three-dimensional (3D) solid object, the operations further comprising acquiring an image of the second wearable token by the camera module;
determining that a form of the 3D solid object corresponds to a defined form of a reference object; and
causing, by the mobile device, the apparatus to perform a second defined operation.
